(19) United States
(12) Patent Application Publication
(10) Pub. No.: US 2016/0313492 A1
(43) Pub. Date: Oct. 27, 2016

(54) CONDUIT FOR COUPLING LIGHT SOURCE INTO THIN WAVEGUIDE FILM

(71) Applicant: QUALCOMM MEMS Technologies, Inc., San Diego, CA (US)

(72) Inventors: Jian Ma, San Diego, CA (US); John Hyunchul Hong, San Clemente, CA (US); Kebin Li, Fremont, CA (US)

(21) Appl. No.: 14/696,055

(22) Filed: Apr. 24, 2015

(51) Int. Cl. F21V 8/00; G09G 5/10

(52) U.S. Cl. CPC G02B 6/0031; G02B 6/0026; G02B 6/0073; G02B 6/0025; G09G 5/10; G09G 2300/04

(57) ABSTRACT

This disclosure provides systems, methods and apparatus for increasing the efficiency of frontlight systems using thin waveguides. In one aspect, a narrowing reflective conduit can be used to condense light from a light source which is thicker than the waveguide, and inject it into the waveguide. A phosphor strip at the exit aperture of the narrowing reflective conduit can inject light with a diffuse directional profile independent of the directional profile of light within the narrowing reflective conduit.

### TECHNICAL FIELD

This disclosure relates to frontlight systems, and in particular frontlight systems which can be used alone or in conjunction with reflective displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

### SUMMARY

The systems, methods and devices of this disclosure each have several innovative aspects, no single one of which is solely responsible for the desirable attributes disclosed herein.

One innovative aspect of the subject matter described in this disclosure can be implemented in an illumination system, comprising a waveguide configured to turn light propagating within the waveguide out of the waveguide; and a reflective conduit disposed adjacent an edge of the waveguide, the reflective conduit including at least a tapering interior section; and an opening at the end of the tapering interior section proximal the edge of the waveguide and aligned with the edge of the waveguide; a light source configured to emit light into the reflective conduit; and phosphor material disposed between the light source and the edge of the waveguide.

In some implementations, a height of the light source can be greater than a thickness of the waveguide. In some implementations, the waveguide can be a planar waveguide. In some implementations, the phosphor material can include a strip of phosphor material disposed within or adjacent the opening in the reflective conduit. In some implementations, the height of the phosphor material at an edge proximate the edge of the waveguide can be approximately equal to the height of the edge of the waveguide. In some implementations, substantially all of the interior surfaces of the reflective conduit can be reflective.

In some implementations, the light source can include a plurality of LEDs disposed along the length of the reflective conduit. In some further implementations, the system can additionally include a diffuser disposed between the phosphor material and the edge of the waveguide. In some still further implementations, the diffuser can be a linear diffuser. In some other further implementations, the plurality of LEDs can be configured to emit generally blue light, and the phosphor can include a yellow phosphor.

In some implementations, the light source can be disposed within the reflective conduit. In some implementations, the reflective conduit can additionally include a widening interior section adjacent the light source. In some implementations, the widening interior section can include at least one concave reflective surface. In some implementations, the system can additionally include a reflective display, where the waveguide is configured to turn light towards the reflective display to illuminate the reflective display.

Another innovative aspect of the subject matter described in this disclosure can be implemented in a reflective conduit, comprising a tapering section having at least one reflective interior surface and terminating in an aperture at a narrow end of the tapering section; phosphorescent material disposed within or adjacent the aperture; a light source configured to emit light into the tapering section of the reflective conduit and energize the phosphorescent material, the light source having a height which is greater than a height of the aperture.

In some implementations, the reflective conduit can extend around the light source. In some implementations, the light source can be supported by a substrate, and the reflective conduit can be secured relative to the substrate to surround the light source. In some implementations, the light source can include a plurality of blue LEDs, and the phosphorescent material can include a yellow phosphor.

In some implementations, the reflective conduit can additionally include a widening section having at least one reflective interior surface, the tapering section located between the widening section and the aperture. In some further implementations, the at least one reflective interior surface of the widening section can be a concave surface. In some implementations, at least one reflective interior surface of the tapering section can be generally planar. In some implementations, the phosphorescent material can be in contact with at least a portion of the tapering section of the reflective conduit.

Another innovative aspect of the subject matter described in this disclosure can be implemented in an illumination system, comprising a waveguide configured to turn light propagating within the waveguide out of the waveguide; and phosphor configured to emit light into an edge of the waveguide; a light source configured to emit light towards the phosphor to energize the phosphor, the light source having a height which is greater than a thickness of the edge of the waveguide; and means for redirecting light emitted by the light source towards the phosphor.

In some implementations, the illumination system can include a reflective conduit having a cavity including a narrowing section, and the means for redirecting light emitted by the light source towards the phosphor can include at least one reflective interior surface of the narrowing section of the cavity. In some further implementations, the cavity can include a widening section adjacent the light source, the cavity having a maximum height at a location between the light source and the phosphor material. In some implementations, the height of the phosphor at the side of the phosphor closest to the edge of the waveguide can be substantially equal to the height of the edge of the waveguide.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a side cross-section of an example of a frontlight system configured to turn incident light out of a waveguide into which a light source injects light.

FIG. 2 shows a side cross-section of another example of a frontlight system which utilizes a thin waveguide.

FIG. 3 shows a side cross-section of another example of a frontlight system which utilizes a thin waveguide in conjunction with a narrowing reflective conduit.

FIG. 4A shows a side cross-section of another example of a frontlight system including a narrowing reflective conduit and a phosphor strip.

FIG. 4B is a top plan view of the frontlight system of FIG. 4A.

FIG. 4C is a perspective view of the frontlight system of FIG. 4A.

FIG. 5 is a detail view of an implementation of a narrowing reflective conduit with a curved interior surface.

FIG. 6 is a flow diagram illustrating a fabrication process for a frontlight system including a thin waveguide.

FIG. 7 is a cross-sectional view of a reflective display device utilizing a frontlight system including a thin waveguide.

FIG. 8 is an isometric view illustration depicting two adjacent interferometric modulator (IMOD) display elements in a series or array of display elements of an IMOD display device.

FIGS. 9A and 9B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In order to illuminate a reflective display or other object, a frontlight system can be disposed over the object to be illuminated. Light can be injected from the side of the frontlight system and into a waveguide, propagating within the light-guiding film until it strikes a reflective light-turning feature and is reflected downward and out of the waveguide to illuminate an underlying object. In some implementations, the waveguide can be made thinner than commercially available LEDs or other appropriate light sources. When a light source is used to inject light into a thin waveguide, the portions of the light source which extend beyond the edges of the thin waveguide will result in light not being injected into the waveguide. In some implementations, a narrowing reflective conduit can be used to direct more light into a thin waveguide. A phosphor strip disposed at the exit of the tapered reflective structure can be used to convert at least part of the light emitted from the LED into light of a different wavelength and to be efficiently coupled into the waveguide. In some implementations, blue light from the LED is converted into yellow light by the phosphor and then is coupled into the waveguide.

Particular implementations of the subject matter described in this disclosure can be implemented to realize one or more of the following potential advantages. When a yellow phosphor material is used in conjunction with blue LEDs, the combination of the blue LEDs and the yellow phosphor can be used to generate white light. The use of an intervening phosphor material can overcome the conservation of Etendue by re-emitting the rays from the phosphor. This re-emission of light using the phosphor material can reduce or eliminate the increased ray angles which can result from reflections within a tapered reflective conduit, and which can reduce the efficiency of the frontlight film into which the light is coupled. The light output at the exit of the tapered reflective conduit has an angular profile similar to that of one or more LEDs disposed adjacent the waveguide, without a tapering reflective conduit, and can be coupled into the waveguide efficiently. Additional light spreading in the horizontal direction can be provided by a linear diffuser disposed between the phosphor material and the waveguide, or any other suitable optical structure. The diffusing properties of the linear diffuser will minimize or eliminate variations in brightness over the waveguide, such as hot spots or areas of increased brightness adjacent the LEDs, and other optical artifacts which can result when the waveguide includes a scribed glass layer or similar component which can include manufacturing irregularities.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber. Other reflective display devices can include, for instance, reflective liquid crystal displays (LCDs) and e-ink displays.

In certain implementations, frontlight systems can be used to provide primary or supplemental illumination for a display device or other object to be illuminated. In particular, reflective display devices such as interferometric modulator-based devices or other electromechanical system (EMS) devices may utilize frontlight systems for illumination due to the opacity of the EMS devices. While a reflective display such as an interferometric modulator-based display may in some implementations be visible in ambient light, some particular implementations of reflective displays may include supplemental lighting in the form of a frontlight system,

In some implementations, a frontlight system may include one or more waveguides or light-guiding layers through which light can propagate, and one or more light-turning features to direct light out of the waveguide. Light can be injected into the waveguide, and light-turning features can be used to reflect light within the waveguide towards a reflective display or other object to be illuminated, and be reflected back in turn through the waveguide towards a viewer. Until light reaches a light-turning feature, the injected light may propagate within the waveguide via total internal reflection when the material of the waveguide has an index of refraction greater than that of the surrounding layers. Such a frontlight system allows an illuminating light source to be positioned at a location offset from the display or other object to be illuminated, such as at one of the edges of the frontlight system.

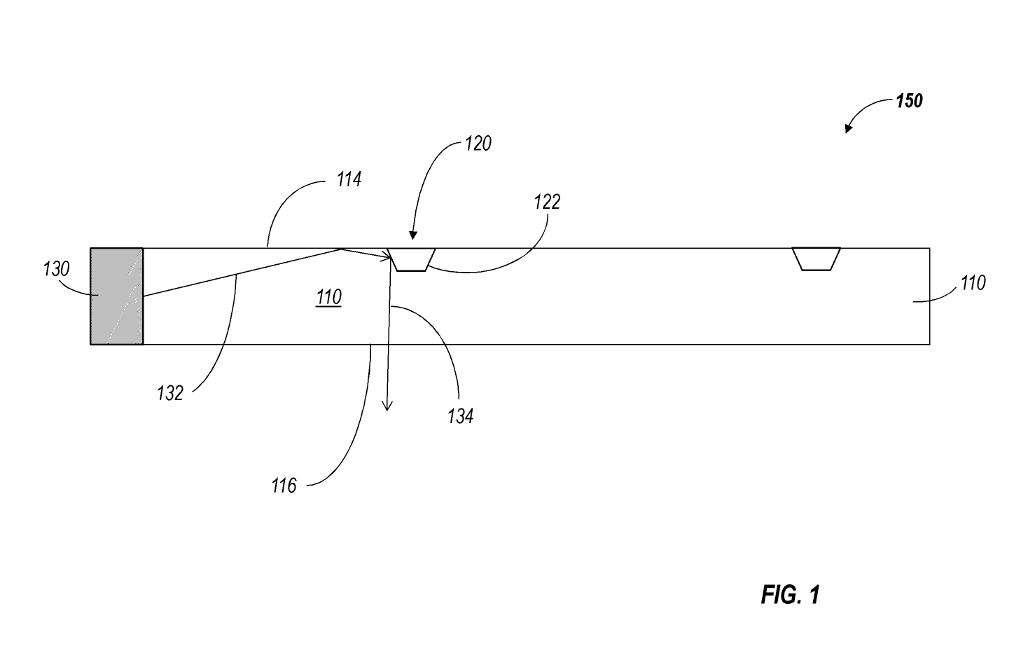

FIG. 1A shows a side cross-section of an example of a frontlight system configured to turn incident light out of plane of the frontlight system. Although one particular implementation of a frontlight system is shown, the implementations described herein can be used in conjunction with any suitable frontlight or backlight systems which includes a waveguide into which light is coupled. The frontlight system 150 includes a waveguide 110 which may have an index of refraction greater than air or any surrounding layers, such as optical adhesives, as discussed above. The waveguide 110 also may include a plurality of light-turning features 120 disposed along an upper surface 114 of the waveguide 110.

These light-turning features 120 include a depression formed in the waveguide 110. The depression may be conical or frustoconical in shape, with the angled sidewall 122 of the depression oriented at an angle to the upper surface 114 and lower surface 116 of light-guiding layer 110. In the illustrated implementation, light can be reflected by total internal reflection at the angled sidewall 122 of the depression, but in other implementations, a reflective layer may be formed over the depression 124, and a masking layer may be formed on the opposite side of the reflective layer from the waveguide 110 to shield reflections from the viewer. Although illustrated for simplicity without a reflective layer, the various implementations described herein may also be used in conjunction with a reflective layer, and may be used in conjunction with any other suitable frontlight or backlight system.

The LED 130 injects light ray 132 into the waveguide 110, which propagates by means of total internal reflection as shown until it strikes an angled sidewall 122 of a light-turning feature 120. The light ray 134 reflected off the angled sidewall 122 of the light-turning feature 120 is turned downwards towards lower surface 116 of the light-guiding layer 110. When the light ray 134 is reflected in a direction sufficiently close to the normal of the lower surface 116 of waveguide 110, the light ray 134 passes through the lower surface 116 of waveguide 110 without being reflected back into the waveguide 110.

In the illustrated implementation, the reflection or transmission of light reaching the angled surfaces of similar light-turning features may be dependent on the angle at which the light 132 is incident upon an angled sidewall 122 of a light-turning feature 120. In contrast, in implementations in which the light-turning features include a reflective layer, all light incident upon the reflective layer will be reflected downwards towards lower surface 116 of the waveguide 110. The use of a reflective layer can therefore reduce light leakage from light-turning features 120, improving the efficiency of the frontlight system 150 as a larger amount of light can be directed downward and towards a reflective display or other object to be illuminated.

Although referred to for convenience as a single layer, the waveguide 110 may in some implementations be a multilayer structure formed from layers having indices of refraction sufficiently close to one another that the waveguide 110 generally functions as a single layer, with minimal refraction and/or total internal reflection between the various sublayers of the waveguide film 110.

The frontlight system 150 thus redirects light 132 propagating within the light-guiding layer downward through the lower surface 116 of the waveguide 110. As illustrated in FIG. 1, the frontlight system relies on the interface between air and the planar sections of the upper surface 114 and the lower surface 116 of frontlight film 110 to constrain light 134 propagating within the frontlight film 110 via total internal reflection (TIR). However, a frontlight system is often used as part of a multilayer structure, and contact between the frontlight film 110 and an adjacent must make sure that the refractive index of film 110 is higher than that of the adjacent material.

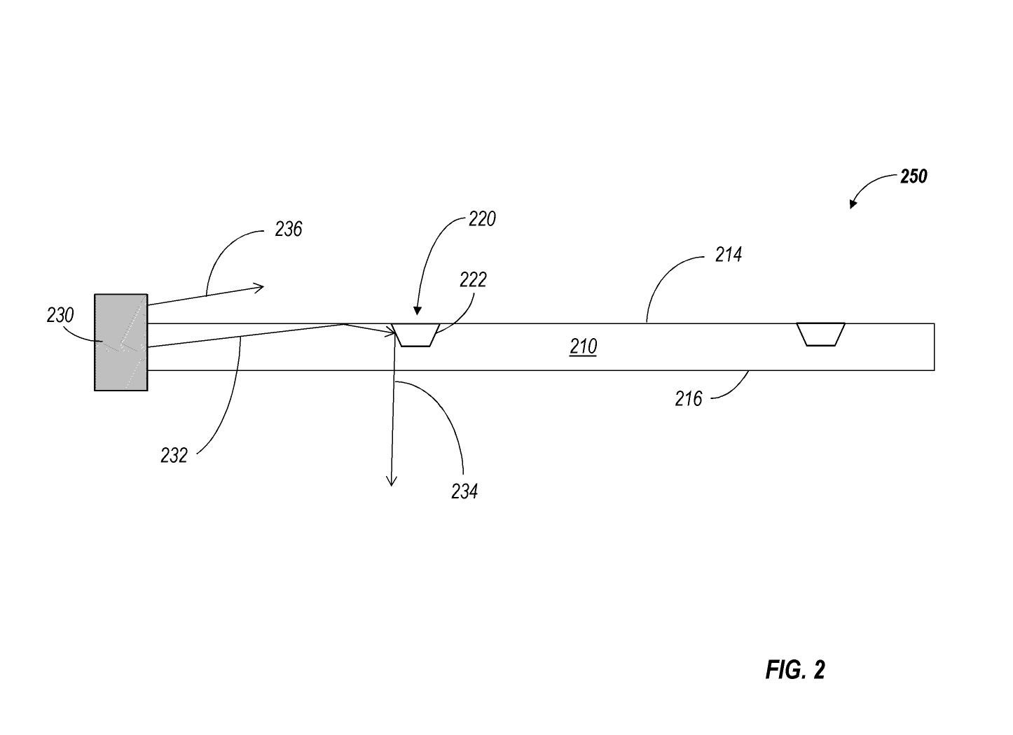

FIG. 2 shows a side cross-section of another example of a frontlight system which utilizes a thin waveguide. The frontlight system 250 is similar to the frontlight system 150 of FIG. 1, except that the waveguide 210 is thinner than the light source 230. Because of this, some light 236 emitted by portions of the light source 230 which extend vertically above or below the edge 212 of the waveguide 210 are not injected into the waveguide 210, reducing the efficiency of the frontlight system 250. In some implementations, the waveguide 210 may be roughly 200 um to 100 um in thickness or thinner, while commercially available blue LEDs may be roughly 300 um in thickness or thicker. The use of such an LED in conjunction with a thin waveguide 210 will result in a substantial amount of light 236 not being injected into the thin waveguide 210. Although the use of a thin waveguide 210 may decrease the overall thickness of a display device including the frontlight system 250, a reduction in the efficiency of the frontlight system 250 can significantly impact the performance of a display device utilizing the frontlight system 250.

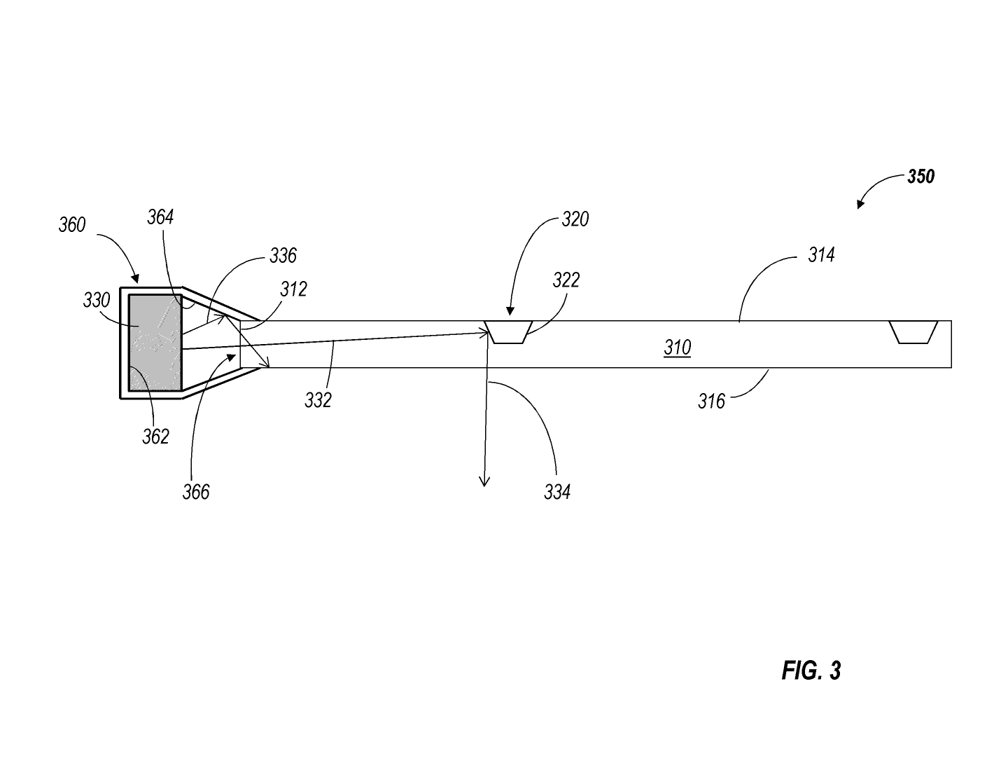

FIG. 3 shows a side cross-section of another example of a frontlight system which utilizes a thin waveguide in conjunction with a narrowing reflective conduit. Like the frontlight system 250 of FIG. 2, the frontlight system 350 of FIG. 3 includes a waveguide 310 which is thinner than the light source 330. However, rather than being disposed directly adjacent the edge 312 of the waveguide 310, the light source 330 is disposed within a tapered reflective conduit 360 which condenses light output from the light source 330 and directs the light towards the edge 312 of the waveguide 310.

The narrowing reflective conduit 360 includes a distal surface 362 that supports one or more light sources 330 such as a white LED, or red, green and blue LEDs. Upper and lower angled surfaces 364 taper downward towards an opening 366 at the end of the conduit 360 proximate the edge 312 of the waveguide 310. The opening 366 may be similar in size and shape to the edge 312 of the waveguide 310. The conduit 360 can be formed via injection molded plastic or any other suitable process, and the interior surfaces 362 and 364 may be coated with a reflective material.

The walls of the conduit 360 may be between 10 um and 50 um in thickness, although in other implementations, the walls of the conduit 360 may be made thicker or thinner, depending on the materials and shape of the conduit 360. The height of the conduit may be between 200 um and 400 um, and the width of the conduit (measured from the point proximate the edge 312 of the waveguide 310 to the point furthest distal the edge 312 of the waveguide 310) may be between 200 um and 600 um, although in other implementations, the conduit may have a height or depth which is smaller or larger than the exemplary dimensions above. The angle of the upper and lower angled surfaces 364 relative to the plane of the substrate will depend in part on the width and height of the conduit 360, but in some implementations, the upper and lower surfaces 364 may make an angle of between 30° and 60° with the plane of the waveguide 310, although larger and smaller angles may also be used in other implementations. In addition, the angles made by the upper and lower surfaces 364 need not be identical to one another, as the conduit 360 may in some implementations be asymmetric.

Light 332 emitted from the light source 330 at a sufficiently large angle to the normal of the proximal surface of the light source 330 will be reflected off of the angled surfaces 364 and directed through the opening 366. However, because of the narrowing taper of the angled surfaces 364, the light reflected off of the angled surfaces 364 is amplified according to the conservation of Etendue and a portion of the light emitted from the light source 330 may be injected into the waveguide 310 at a angle to the upper and lower surfaces 314 and 316 of the waveguide 310 larger than the total internal reflection (TIR) angle at the interface 314 and 316. Light injected at a sufficiently large angle to the upper surface 314 or lower surface 316 will leak out from the waveguide 310 at the very first bounce and cannot propagate. As such, the efficiency of the frontlight system is reduced.

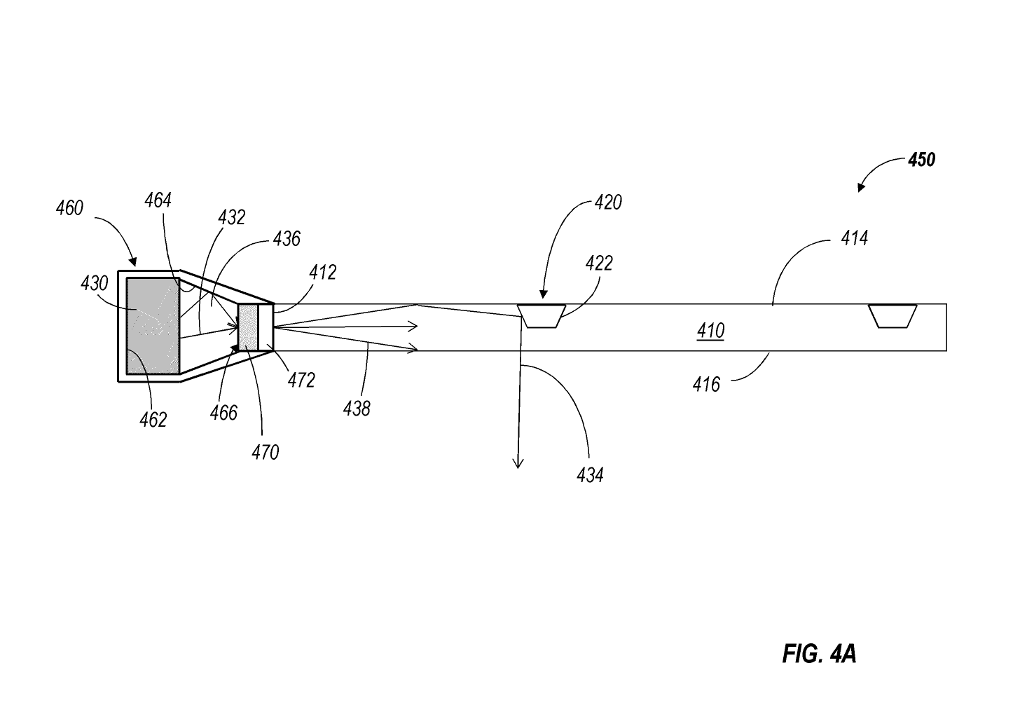

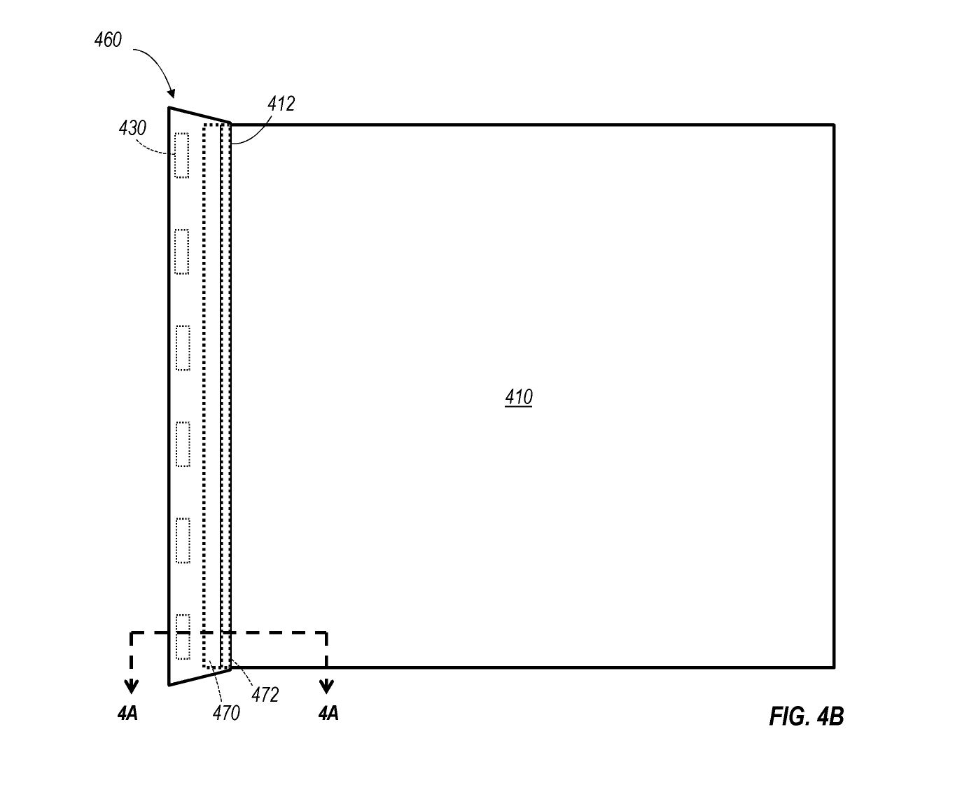

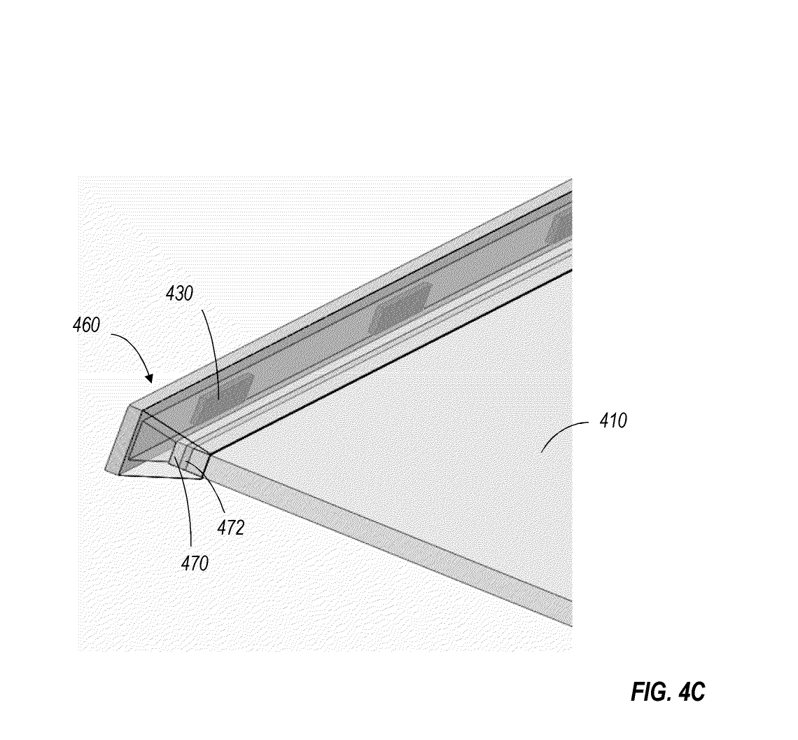

FIG. 4A shows a side cross-section of an example of a frontlight system including a narrowing reflective conduit and a phosphor strip. FIG. 4B is a top plan view of the frontlight system of FIG. 4A. FIG. 4C is a perspective view of the frontlight system of FIG. 4A. As can be seen in FIG. 4A, the frontlight system 450 of FIG. 4A differs from the frontlight system 350 of FIG. 3 in that a strip of phosphor material 470 is disposed adjacent the opening 466 at the end of the narrowing reflective conduit 460 proximal the edge 412 of the waveguide 410. Light emitted from the light source 430 is directed to the phosphor strip 470, either as a light ray 432 traveling directly to the phosphor strip 470 from the light source 430, or as a light ray 436 which is initially directed away from the phosphor strip 470 but is redirected towards the phosphor strip 470 by the reflective interior surface 464 of the narrowing conduit 460. The interior reflective surfaces of the narrowing conduit 460 provide a means for directing light towards the opening 466 at the tapered end of the narrowing conduit 460. Although illustrated as surrounding the light source 430, with the rear surface 462 an integral part of the conduit 460. In other implementations, however, the rear surface may be part of a printed circuit board or other component supporting one or more light sources 430, and the reflective conduit 460 may be open ended and secured to the printed circuit board to form a cavity surrounding the one or more light sources 430.

Light rays 432 and 436 impinging upon the phosphor strip 470 energize the phosphor material, and the phosphor strip 470 in turn emits light 438 into the waveguide 410. In some implementations, the light source 430 may be a blue LED, and the phosphor may be a yellow phosphor, so that the light emitted from the phosphor combined with part of the blue light from LED that is not absorbed by the phosphor will visually appear to be white light. In some particular implementations, the light source 430 may be an LED which emits a substantial percentage of visible light at wavelengths shorter than about 460 nm. Other combinations of light sources and phosphor materials may also be used. The intervening phosphor strip 470 results in the light 438 emitted from phosphor into the waveguide 410 having a directional profile which is substantially independent of the directional profile of the light rays 432 and 436. The light 438 emitted from the energized phosphor strip will have a generally lambertian directional profile that is similar to or identical to the directional profile of a common phosphor based white LED which is coupled directly to the waveguide without the use of a tapering reflective conduit. However, additional light-shaping components may be used to further shape the light 438.

As can be seen in FIGS. 4B and 4C, the light source may be formed from a plurality of individual light sources 430 disposed along at least one edge 412 of the waveguide 410. When the light sources 430 are LEDs, for example, they may emit a substantial percentage of their light in a conical shape, and other discrete light sources may have similar illumination patterns. Because of this, the amount of light impinging upon and energizing a particular section of the phosphor strip 470 will be dependent upon the distance between that particular section of the phosphor strip 470 and the closest light source 430. Although the light emitted by any given section of the phosphor strip 470 will have a diffuse directional profile, the brightness of the phosphor strip 470 may vary across the length of the phosphor strip. In order to provide more even light injection across the edge 412 of the waveguide 400, a light-shaping structure such as a linear diffuser 472, which may include a row of lenticular structures, can be used to spread light within the plane of the waveguide 410. The linear diffuser 472 can be disposed between the phosphor strip 470 and the waveguide 410, and can be used to reduce the distance by which the light source is set back from the edge 412 in order to provide even illumination throughout the frontlight system 450.

The reflective conduit 460 serves to direct light out of an opening 466 which can have a height less than the height of the light source 430. The reflective conduit 460 allows a light source 430 to be used efficiently in conjunction with waveguide 410 with a thickness less than the height of the light source 430. However, some light emitted from the light source 430 will be reflected back towards the light source 430, reducing the efficiency of the frontlight system 450. The use of a widening reflective surface adjacent the rear of the narrowing conduit can direct light emitted from the light source 430 at a large angle to the plane of the waveguide 410 forward and towards the opening at the end of the narrowing conduit proximate the injection edge 412 of the waveguide 410.

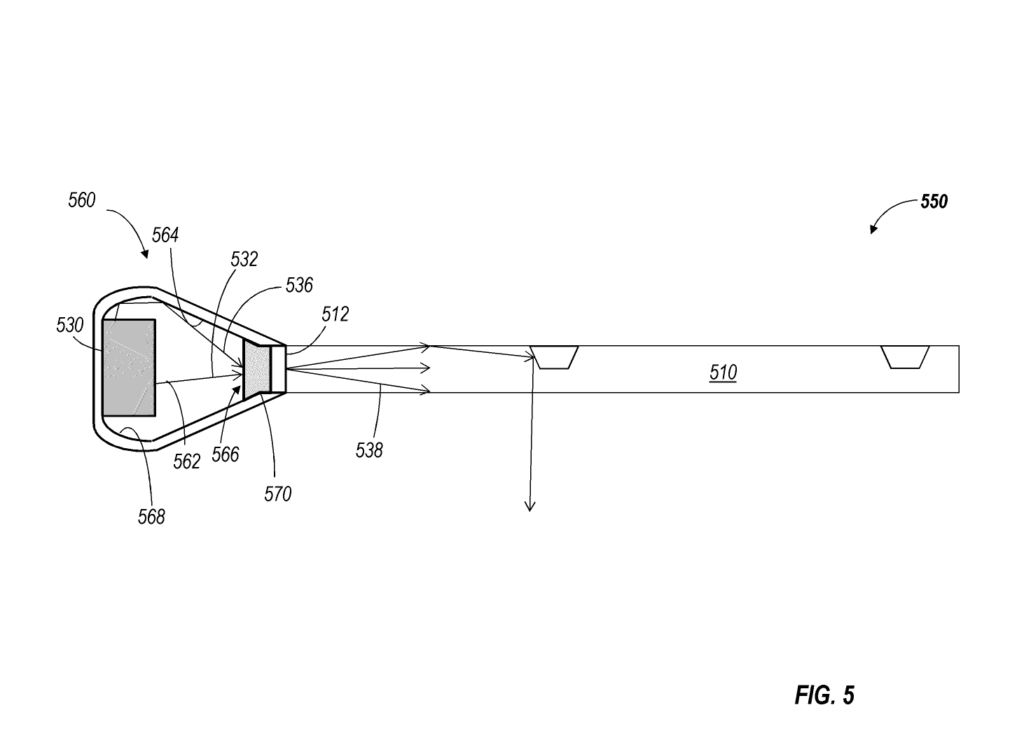

FIG. 5 is a detail view of another implementation of a narrowing reflective conduit with a curved interior surface. The reflective conduit 560 is similar to the reflective conduit 460 of FIG. 4, but differs slightly in that the section of the reflective conduit distal the injection edge 512 of the waveguide 510 first widens before narrowing towards the opening 566 opposite the light source 530. In the implementation illustrated in FIG. 5, the reflective conduit 560 includes concave reflective surfaces 568 above and below the light source 530. The distal surface of the reflective conduit 560 is illustrated as a planar surface in the illustrated implementation, but in other implementations the reflective surfaces 568 can come together behind the light-source 530 such that the entire rear interior surface of the reflective conduit 560 is curved.

Although the widening portion of the conduit 560 consists of a curved reflective surface 568, the widening portion may on other implementations be planar, or be less curved. The use of a curved surface may allow light emitted at a variety of angles from light source 530 to be directed forward at in a direction which is close to parallel with the plane of the waveguide 510, increasing the amount of light which is emitted from the light source 530 and reaches the phosphor strip 570. Multiple planar surfaces at gradually changing angles can also be used to approximate a curved surface and achieve a similar effect.

Light rays 536 emitted at a large angle to the plane of the waveguide 510 can first be reflected off of the curved reflective surfaces 568 within the widening portion of the reflective conduit 560 and reflected towards the phosphor strip 570 disposed adjacent or within the opening 566 in the reflective conduit 560. Depending on the particular angle of the light ray 536, and the shape of the reflective surfaces 568 within the widening portion, the light ray 536 may be reflected off of one or more of the angled reflective surfaces 564 within the narrowing portion of the reflective conduit 560 before being reflected into the phosphor strip 570. The initial forward reflection of such light rays by the widening portion of the reflective conduit 560 can increase the percentage of light emitted from the light source 530 which is incident on the phosphor strip 570, increasing the efficiency of the frontlight system 550.

In the illustrated implementation, the phosphor strip 570 extends further into the reflective conduit 560 than the phosphor strip 470 of FIGS. 4A through 4C, such that the phosphor strip 570 is in contact with portions of the angled reflective surfaces 564 within the narrowing portion of the reflective conduit 560. Such an arrangement increases the area of the phosphor strip 570 exposed to the interior of the narrowing conduit 560, which may increase the amount of light which is reflected into the phosphor strip 570. The size and shape of the phosphor strip may be varied in a similar manner in each of the implementations discussed herein.

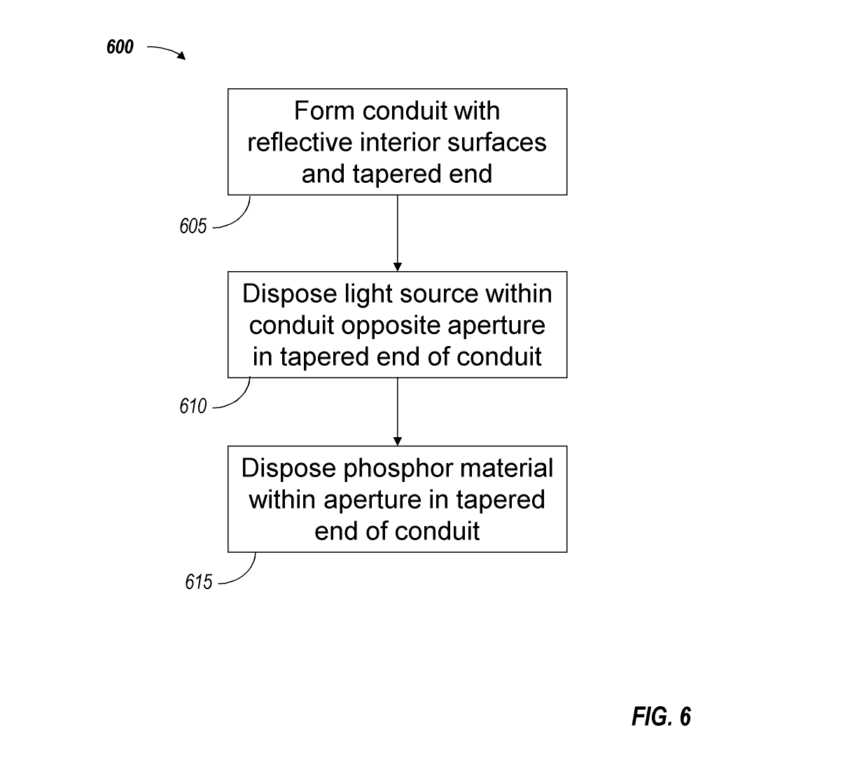

FIG. 6 is a flow diagram illustrating a fabrication process for a frontlight system including a thin waveguide. In block 605 of the fabrication process 600, a conduit with a tapered end and reflective interior surfaces is formed. In some implementations, the conduit may be formed by an injection molding process or other suitable process, and then some or all of the interior surfaces of the conduit may be coated with a reflective material. In other implementations, the conduit may itself be formed from a reflective material.

In some implementations, the conduit has a single opening at the tapered end, while in other implementations the conduit may be partially open at the distal end opposite the tapered end, and may be dimensioned and configured to receive a printed circuit board or other component supporting a light source. In some implementations, the widest point of the conduit may be at the distal end, and the conduit may taper from the distal end towards the tapered end, while in other implementations there may be a widening portion at the distal end to increase the efficiency of the conduit as a light-gathering structure.

In block 610 of the fabrication process 600, a light source is disposed within the distal end of the conduit. The light source may in some implementations be one or more discrete LEDs spaced apart from one another, although other appropriate light sources may also be used. In particular implementations, the LEDs may be blue LEDs, or LEDs which emit a substantial percentage of their light at wavelengths shorter than about 460 nm.

In block 615 of the fabrication process 600, a strip of phosphor material is disposed within or adjacent the opening at the tapered end of the conduit. A variety of sizes and shapes of phosphor strips may be used, as discussed above. In some implementations, the phosphor material may be disposed solely within the opening at the tapered end of the conduit, while in other implementations, the phosphor materal can extend inward into the tapered area of the conduit, and end at the opening of the conduit. Light which is directed towards the opening of the conduit will impinge upon and energize the phosphor strip, which in turn emits light in a diffuse distribution pattern. Additional components such as a linear diffuser or other light-shaping structures may also be disposed on the opposite side of the phosphor strip as the light source, and the reflective conduit structure including the light source and the phosphor strip may be disposed adjacent a waveguide with light turning features, so that light emitted from the phosphor strip will be injected into the waveguide as part of a frontlight system. The waveguide may include lower-index cladding layers applied on one or both sides of the waveguide. The waveguide may also include an antireflective coating, which can in some implementations be applied prior to the application of the low-index cladding layers. Additional components, such as touch systems, may be applied after application of the low-index cladding layer. The multilayer structure may also be adhered to or secured relative to a display substrate to form part of a display device including a frontlight system.

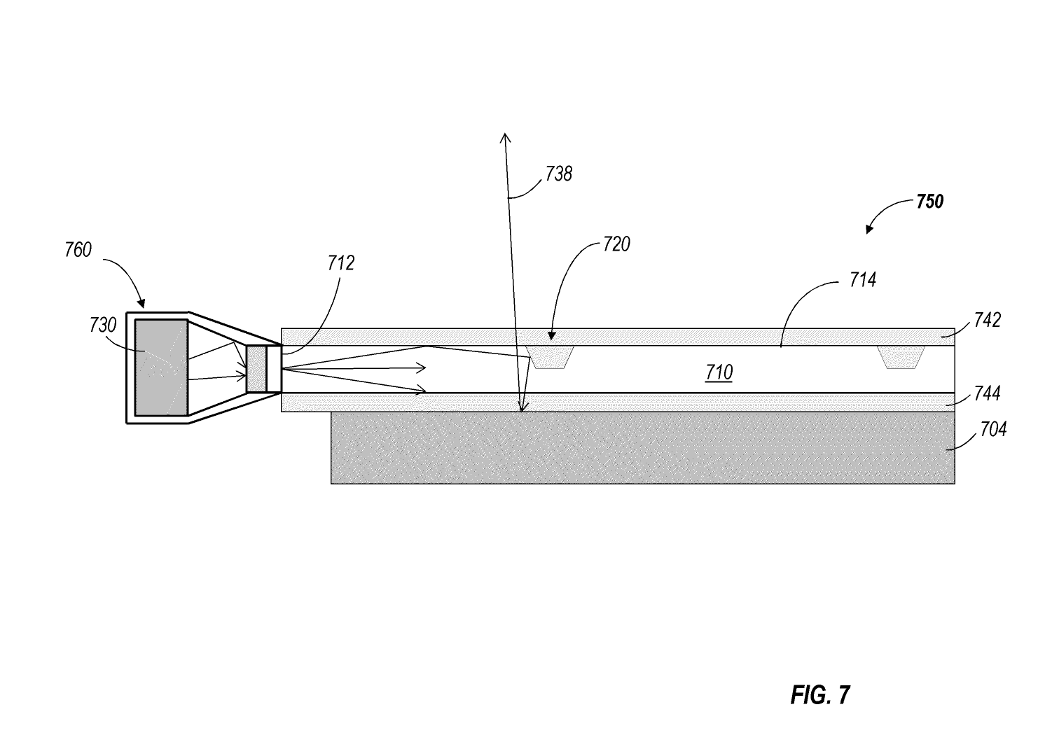

FIG. 7 is a cross-sectional view of a reflective display device utilizing a frontlight system including a thin waveguide. The reflective display device 750 includes a light source 730 disposed within a narrowing reflective conduit 760 such as the narrowing reflective conduit of FIGS. 4A through 4C and FIG. 5, disposed adjacent an injection edge 712 of a waveguide 710. The reflective display device 750 also includes an upper cladding layer 742 and a lower cladding layer 744 disposed on either side of the waveguide 710. The upper cladding layer 742 and lower cladding layer 744 can be formed from a material which has a lower index of refraction than the waveguide 710. As can be seen in FIG. 7, the upper cladding layer is formed over the upper surface 714 of the waveguide 710 and is in contact with the planar portions of the upper surface 714 of the light-guiding layer 710 extending between the light-turning features 720, filling the depressions of the light-turning features 720. These contact areas form an interface between the lower-index upper cladding layer 742 and the planar sections of the higher-index waveguide 710 in order to facilitate total internal reflection of light propagating within the light-guiding layer before it reaches a light-turning feature 720.

A reflective display 704 may be disposed on the opposite side of the lower cladding layer 744 as the waveguide 710. Light turned out of the waveguide 710 may be reflected off of the reflective display 704 and back towards a viewer as light ray 738.

Additional components may also be included in various implementations of display devices, such as an antireflective film, a touch-sensing system, and a protective cover glass. Although depicted as illuminating a reflective display, the above implementations of frontlight systems and components may be used to illuminate a wide variety of objects in addition to reflective displays. One non-limiting example of a reflective display type with which the frontlight systems and components described herein may be used is an interferometric modulator (IMOD) based display.

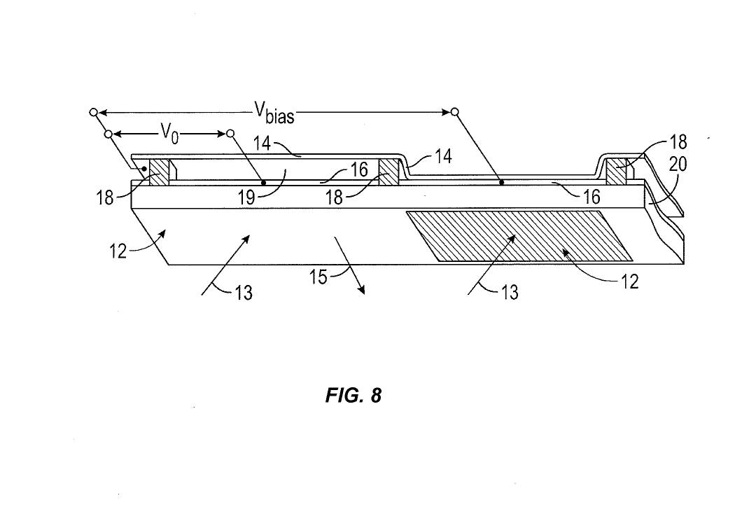

FIG. 8 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 8 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 8, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 8 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 8, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 8. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

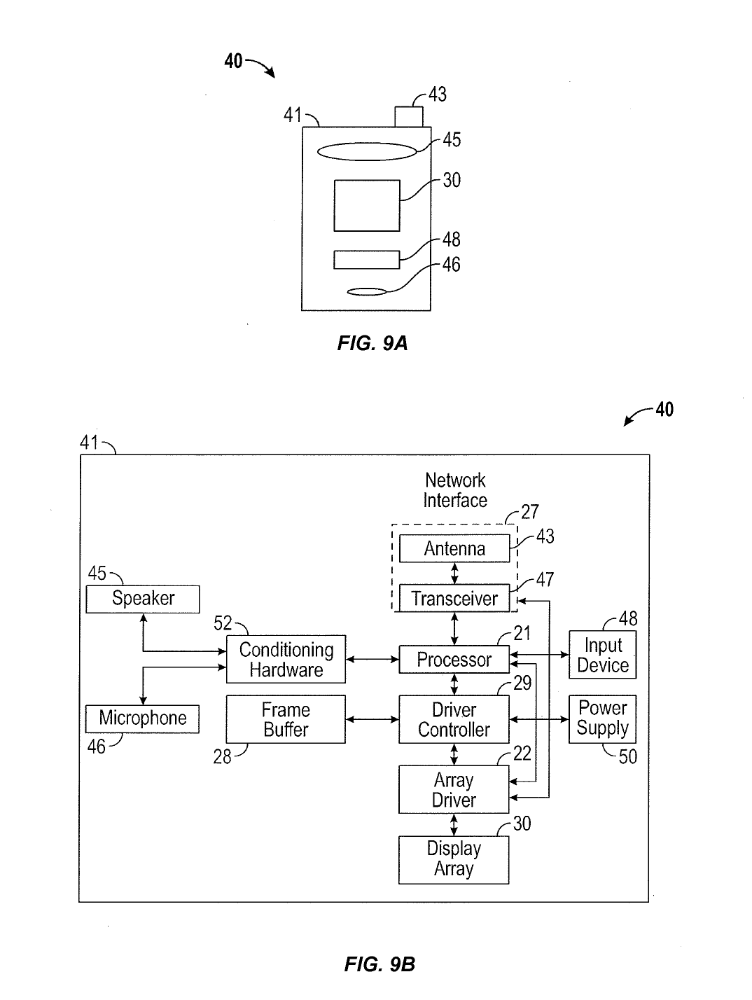

FIGS. 9A and 9B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 9A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 9A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An illumination system, comprising:
a waveguide configured to turn light propagating within the waveguide out of the waveguide; and
a reflective conduit disposed adjacent an edge of the waveguide, the reflective conduit including at least:
a tapering interior section; and
an opening at an end of the tapering interior section proximal the edge of the waveguide and aligned with the edge of the waveguide;
a light source configured to emit light into the reflective conduit; and
phosphor material disposed between the light source and the edge of the waveguide.

2. The illumination system of claim 1, wherein a height of the light source is greater than a thickness of the waveguide.

3. The illumination system of claim 1, wherein the waveguide is a planar waveguide.

4. The illumination system of claim 1, wherein the phosphor material includes a strip of phosphor material disposed within or adjacent the opening in the reflective conduit.

5. The illumination system of claim 1, wherein a height of the phosphor material at an edge of the phosphor material proximate the edge of the waveguide is approximately equal to a height of the edge of the waveguide.

6. The illumination system of claim 1, wherein substantially all of the interior surfaces of the reflective conduit are reflective.

7. The illumination system of claim 1, wherein the light source includes a plurality of LEDs disposed along a length of the reflective conduit.

8. The illumination system of claim 7, additionally including a diffuser disposed between the phosphor material and the edge of the waveguide.

9. The illumination system of claim 8, wherein the diffuser is a linear diffuser.

10. The illumination system of claim 7, wherein the plurality of LEDs are configured to emit generally blue light, and wherein the phosphor material includes a yellow phosphor.

11. The illumination system of claim 1, wherein the light source is disposed within the reflective conduit.

12. The illumination system of claim 1, wherein the reflective conduit additionally includes a widening interior section adjacent the light source.

13. The illumination system of claim 13, wherein the widening interior section includes at least one concave reflective surface.

14. The illumination system of claim 1, additionally including a reflective display, wherein the waveguide is configured to turn light towards the reflective display to illuminate the reflective display.

15. The illumination system of claim 14, additionally including:
a processor that is configured to communicate with the reflective display, the processor being configured to process image data; and
a memory device that is configured to communicate with the processor.

16. The illumination system of claim 15, additionally including:
a driver circuit configured to send at least one signal to the reflective display; and
a controller configured to send at least a portion of the image data to the driver circuit.

17. The illumination system of claim 15, additionally including an image source module configured to send the image data to the processor, wherein the image source module comprises at least one of a receiver, transceiver, and transmitter.

18. The illumination system of claim 15, additionally including an input device configured to receive input data and to communicate the input data to the processor.

19. A reflective conduit, comprising:
a tapering section having at least one reflective interior surface and terminating in an aperture at a narrow end of the tapering section;
phosphorescent material disposed within or adjacent the aperture;
a light source configured to emit light into the tapering section of the reflective conduit and energize the phosphorescent material, the light source having a height which is greater than a height of the aperture.

20. The reflective conduit of claim 19, wherein the reflective conduit extends around the light source.

21. The reflective conduit of claim 19, wherein the light source is supported by a substrate, and wherein the reflective conduit is secured relative to the substrate to surround the light source.

22. The reflective conduit of claim 19, wherein the light source includes a plurality of blue LEDs, and wherein the phosphorescent material includes a yellow phosphor.

23. The reflective conduit of claim 19, wherein the reflective conduit additionally includes a widening section having at least one reflective interior surface, the tapering section located between the widening section and the aperture.

24. The reflective conduit of claim 23, wherein the at least one reflective interior surface of the widening section is a concave surface.

25. The reflective conduit of claim 19, wherein at least one reflective interior surface of the tapering section is generally planar.

26. The reflective conduit of claim 19, wherein at the phosphorescent material is in contact with at least a portion of the tapering section of the reflective conduit.

27. An illumination system, comprising:
a waveguide configured to turn light propagating within the waveguide out of the waveguide; and
phosphor configured to emit light into an edge of the waveguide;
a light source configured to emit light towards the phosphor to energize the phosphor, the light source having a height which is greater than a thickness of the edge of the waveguide; and
means for redirecting light emitted by the light source towards the phosphor.

28. The illumination system of claim 27, wherein the illumination system includes a reflective conduit having a cavity including a narrowing section, and wherein the means for redirecting light emitted by the light source towards the phosphor include at least one reflective interior surface of the narrowing section of the cavity.

29. The illumination system of claim 28, wherein the cavity includes a widening section adjacent the light source, the cavity having a maximum height at a location between the light source and the phosphor.

30. The illumination system of claim 27, wherein the height of the phosphor at the side of the phosphor closest to the edge of the waveguide is substantially equal to the height of the edge of the waveguide.
